(19) United States
(12) Patent Application Publication
(10) Pub. No.: US 2010/0248194 A1
(43) Pub. Date: Sep. 30, 2010

(54) TEACHING SYSTEM AND METHOD

(76) Inventors: Adithya Renduchintala, Harrisonburg, VA (US); Jack August Marmorstein, Harrisonburg, VA (US); Gregory Keim, Broadway, VA (US); Alisha Huber, Dayton, VA (US)

Correspondence Address: Kaplan Gilman & Pergament LLP, 1480 Route 9 North, Woodbridge, NJ, 07095, US

(21) Appl. No.: 12/412,472

(22) Filed: Mar. 27, 2009

(51) Int. Cl. G09B 19/00; G09B 5/00; G09B 19/06

(52) U.S. Cl. 434/169; 434/167; 434/157

(57) ABSTRACT

A student using a teaching system, for example, to learn a language, selects a concept, for example a word or phrase, which he does not recall. On a display, he is immediately presented with an array of images or graphics related to the selected concept. For example, the graphics or images may be from previous lessons which involve the concept. If the student then selects one of the images or graphics he is presented with a list of all the concepts, for example, words and phrases, associated with that image or graphic. The student is thereby able to recollect the selected concept in the context of all of his previous experiences with it. If that does not restore the selected concept to his recollection, he is able to select additional images and graphics, in each case being presented with an additional list of related concepts, making it likely that the originally selected concept will be recalled.

### TEACHING SYSTEM AND METHOD

The present patent application relates generally to a teaching system and method and, more particularly, concerns using an array of graphics and images related to an inquiry to immerse the student in the subject matter and enhance learning and retention of information.

### BACKGROUND OF THE INVENTION

Traditionally, learning a language involves a great deal of memorization. Interest can be added by introducing stories, presenting pictures and learning songs, but ultimately, the student must do a great deal of memorization in order to be successful. That includes not only memorizing words but memorizing rules of grammar and proper usage.

Then, oral and written communication becomes a chore of translating mentally from one's native language. Spoken communication becomes particularly difficult, as a student translates a phrase mentally from the foreign language, composes an answer in his native language, and translates, again mentally, to the foreign language. Carrying on an intelligent conversation becomes difficult, because the student is preoccupied with these mental gymnastics and searching for words. Instead of interacting with the other person, the student speaks haltingly, and often ungrammatically. His success is greatly dependent upon the quality of his memory.

In contrast, when we first learn to speak our native language, we are totally immersed in the experience. Any object around us, every experience, every interaction and every memory is a reminder of the words we learn and reinforces the learning experience. Words come to us naturally because of those associations, which place all of the words we learn into context.

If a student learning a new language could be similarly immersed in the experience, it would not only become more enjoyable, but the student could learn more quickly and more efficiently, and would be likely to retain more of what he learns.

Systems for teaching language through such immersion techniques are marketed by the assignee of the present invention. However, there exists a need for improved methodologies of more completely immersing a student in a target language to be learned.

### SUMMARY OF THE INVENTION

In accordance with the present invention, a student using a teaching system, for example, to learn a language, selects a concept which he does not recall. The selection may be a single word, or a phrase comprised of plural words.

On a display, he is immediately presented with an array of images or graphics related to the selected concept. For example, the graphics or images may be from previous lessons which involve the concept. If the student then selects one of the images or graphics he is presented with a list of all the concepts, for example, words and phrases, associated with that image or graphic. The student is thereby able to recollect the selected concept in the context of all of his previous experiences with it. If that does not restore the selected concept to his recollection, he is able to select additional images and graphics, in each case being presented with an additional list of related concepts, making it likely that the originally selected concept will be recalled.

As importantly, the process of forcing the user to again associate images with the word or phrase results in further reinforcement of the association between the images and the word or phrase at issue. This is turn, emphasizes the immersion in the target language being learned.

### BRIEF DESCRIPTION OF THE DRAWINGS

The foregoing brief description and further objects, features and advantages of the present invention will be understood more completely from the following detailed description of a presently preferred, but nonetheless illustrative, embodiment in accordance with the present invention, with reference being had to the accompanying drawings, in which:

FIG. 1 is a schematic representation of a screenshot taken from a teaching machine embodiment of the present invention on which a student is studying German;

FIG. 2 is fragmentary view of the portion of FIG. 1 containing image/graphic 12-1, with a drop-down list below the image/graphic, after it has been selected by a student;

FIG. 3 is a block diagram representing a computer C after it has been programmed to run a computer teaching system embodying the present invention;

FIG. 4 depicts an exemplary embodiment of the present invention;

FIG. 5 depicts an example of other aspects of the present invention;

FIG. 6 shows other aspects of an exemplary embodiment of the invention;

FIG. 7 depicts an example of the intersection of two sets of images;

FIG. 8 depicts several intersections of various sets of images;

FIG. 9 depicts another example of the present invention;

FIG. 10 depicts still another exemplary embodiment of the present invention;

FIG. 11 depicts a set of relationships that may be triggered between items on which a user action is received, and further items to be displayed;

FIG. 12 depicts a multiple text display embodiment;

FIG. 13 depicts a related word embodiment.

### DETAILED DESCRIPTION OF THE PREFERRED EMBODIMENTS

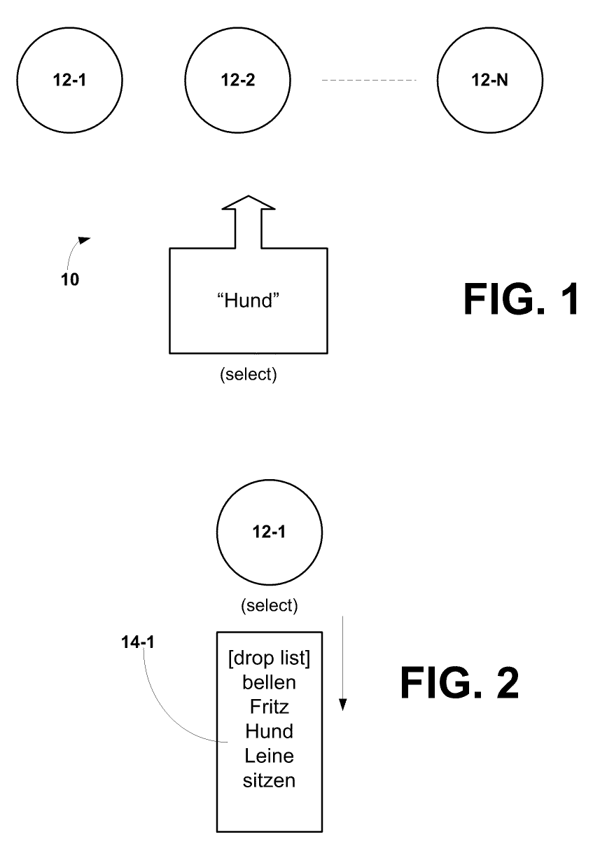

FIG. 1 is a schematic representation of a screenshot taken from a teaching machine embodiment of the present invention on which a student is studying German. He has encountered the word “Hund” (dog) and is uncertain of its meaning. He has entered the word “Hund”, either by typing it or highlighting it in an article and then enlisting a special help function of the teaching machine, either by entering a key combination or clicking on a designated part of the screen. In response, a plurality of images and/or graphics 12-1 . . . 12-N have popped onto the screen. Each image/graphic shows a scene that is related to a dog. Preferably, at least some of the scenes are from a lesson that the student has already had. For example, image 12-1 might be derived from a story about a man and his dog. It depicts a man walking a dog, Fritz, at the end of a leash. The dog has sat down and is barking. It is likely that, upon seeing this image and/or one of the other images, the student may very well recall the meaning of Hund. However, should he still not recall the meaning of Hund, he might click on or otherwise select image 12-1, at which point a drop-list 14-1 appears below image 12-1, as depicted in FIG. 2. This list, for example, includes the words “bellen” (barking), Fritz, Hund, “Leine” (leash) and “sitzen” (sitting).

In a still further embodiment of the invention, the system automatically retrieves a record of any and all lessons that are part of the language curriculum, which include the word Hund, and which the student has successfully completed. The student is then forced to recall the prior lessons, and correlate the item they have in common, reinforcing the student's knowledge of the particular word or phrase at issue.

At this point, the student will, in all probability, recall the meaning of the word Hund. However, if he does not, he can continue to click on additional graphics/images to view additional lists. For example, suppose the student clicked on image 12-2, which shows Fritz standing in front of his doghouse sniffing Felix the cat, who is in the process of jumping onto the doghouse. The drop-list for image 12-2 might include: Felix, Fritz, Hund, Hundhause (doghouse), Katz (cat), snuffeln (sniffing), and stehen (standing). By clicking on a particular image, the student may be presented with a list of words from all prior lessons that were taught using the specific image.

After viewing the array of images/graphics and one or more drop-down lists, just about any student will have received a sufficient amount of immersive reinforcement to inscribe the word Hund well into his mind. Moreover, it will have been obtained in a very natural, intuitive manner, much the way a child first learns to speak a language.

It should be appreciated that the originally selected objects (and any other selected objects) need not be a word but may be a phrase. Similarly, the drop-down list may include one or more phrases associated with the images. Also, the objects need not be written but may be spoken words or phrases to teach a student the spoken language. For example, the student might click on an icon that causes a word or phrase to be spoken. The word or phrase may or may not be printed on or near the icon. Similarly, some of the objects may be printed and others audible.

Although the described method of teaching is particularly effective for teaching language, it is not that limited and is, in fact, applicable to teaching virtually any subject. For example, it could lend itself very well to teaching history, economics, mathematics, or science. It is useful in any situation in which the same image or set of images are used in connection with teaching different concepts.

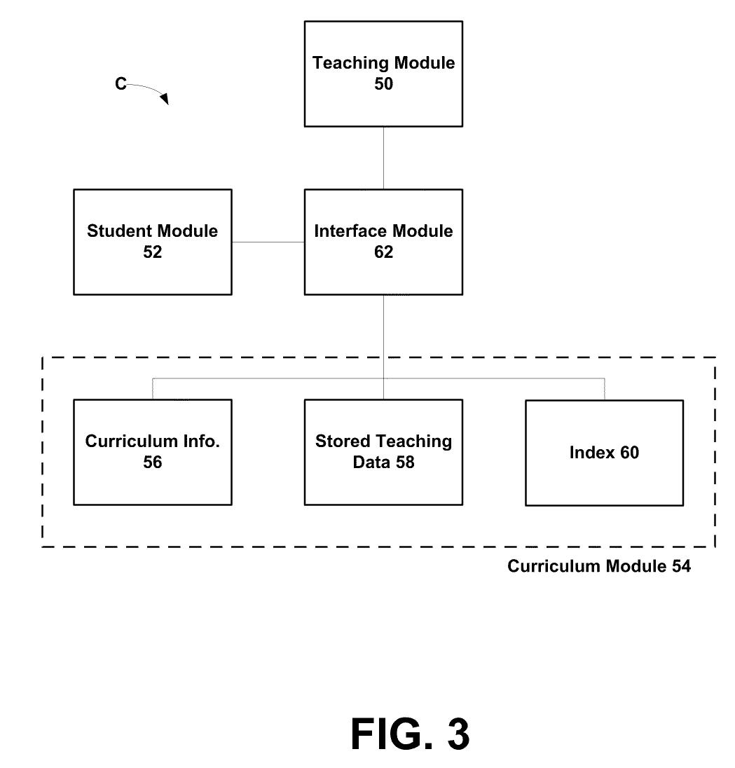

FIG. 3 is a block diagram representation of the computer C after it has been programmed to run the teaching program. The computer has a teaching interface module 50 which performs all of the processing associated with teaching any subject, including presentation of curriculum modules, accepting questions and presenting answers, propounding test questions and accepting answers and controlling storage of student information, evaluation of performance, and pacing the presentation of the preprogrammed curriculum. One of its functions is to detect when the student propounds an inquiry that will launch the array of images/graphics. It will handle such an inquiry as an interrupt so that it is unavailable only in exceptional circumstances, such as when the student is taking a test.

Information related to a specific student is stored in a unique Student Module 52. It will be appreciated that there will be a module 52 for each student, so a plurality of such modules would typically be present. Computer C would also typically include a plurality of Curriculum Modules 54, one for each subject being taught.

Each Curriculum Module includes curriculum information storage 56, which includes the content and sequence of all the lessons, test questions and answers, and instructions on how to proceed, based upon test results. The actual information related to the lessons, such as stories, graphics and images is stored Teaching Data Storage 58. When the curriculum module is first created, an index 60 is created which relates the words in each lesson with the corresponding images/graphics.

An Interface Module 62 permits teaching module 50 to interface with Student Modules 52 and Curriculum Modules 54. Interface Module 62 includes a database manager which permits the generation of queries and efficient transfer of information between Teaching Module 50 and Student Modules 52 and Curriculum Modules 54. In operation, when the student acts to create an interrogation of the type that causes the array of images/graphics, Interface Module 62 generates a database query for the search term that is addressed to the index 60 and will cause storage 58 to return the appropriate images and graphics. Subsequently, should the student select one of the images/graphics, Interface Module 62 generates a database query for the image that is addressed to the index 60 and will cause storage 58 to return the appropriate, related words or phrases.

Although the preferred method has been described in terms of a teaching machine, in the modern context, it is preferably in the form of a personal computer running a teaching program. As is typical, the computer will include a display, a keyboard, a pointing device, a processing unit programmed to run the program, and one or more mass storage devices.

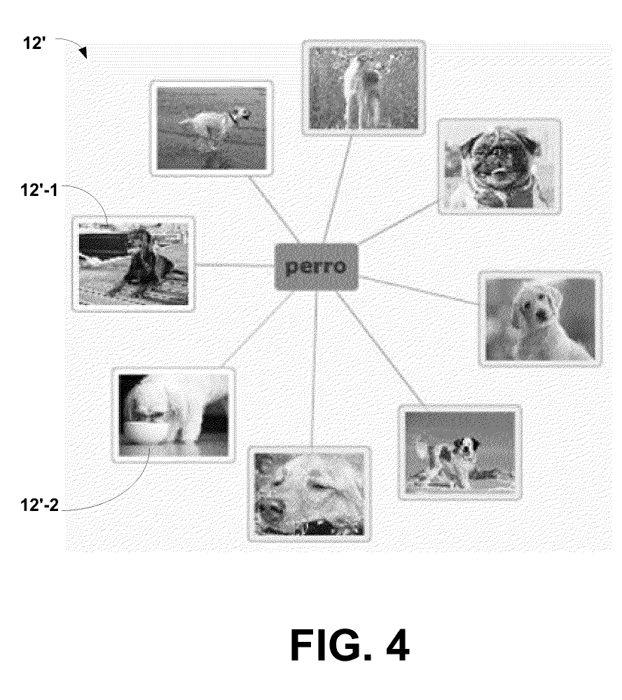

FIG. 4 is a representation of a screenshot taken from an alternate embodiment of a teaching machine in accordance with the present invention, on which a student is studying Spanish. He has encountered the word “perro” (dog) and is uncertain of its meaning. He has entered the word “perro”, either by typing it or highlighting it in an article and then enlisting a special function of the teaching machine, either by entering a key combination or clicking on a designated part of the screen. In response, the screen displays the word “perro” surrounded by a cluster 12′ including a collection of images of dogs in a kind of star pattern, surrounding the word “perro.”

Preferably, at least some of these images are from a lesson that the student has already had. In one embodiment, the images are all from lessons the student previously completed. Alternatively, if the student has only completed a prescribed number of lessons (e.g.; 1 or 2) that have used the word, then images from other lessons not yet completed can be used to supplement. Or, if the student has not completed any lesson that has used the word, the images can all be from lessons never completed.

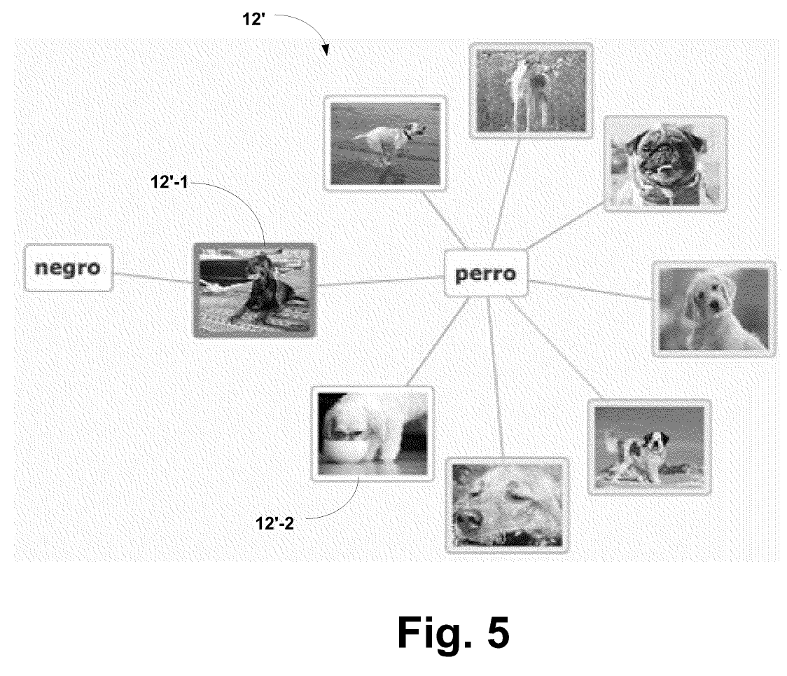

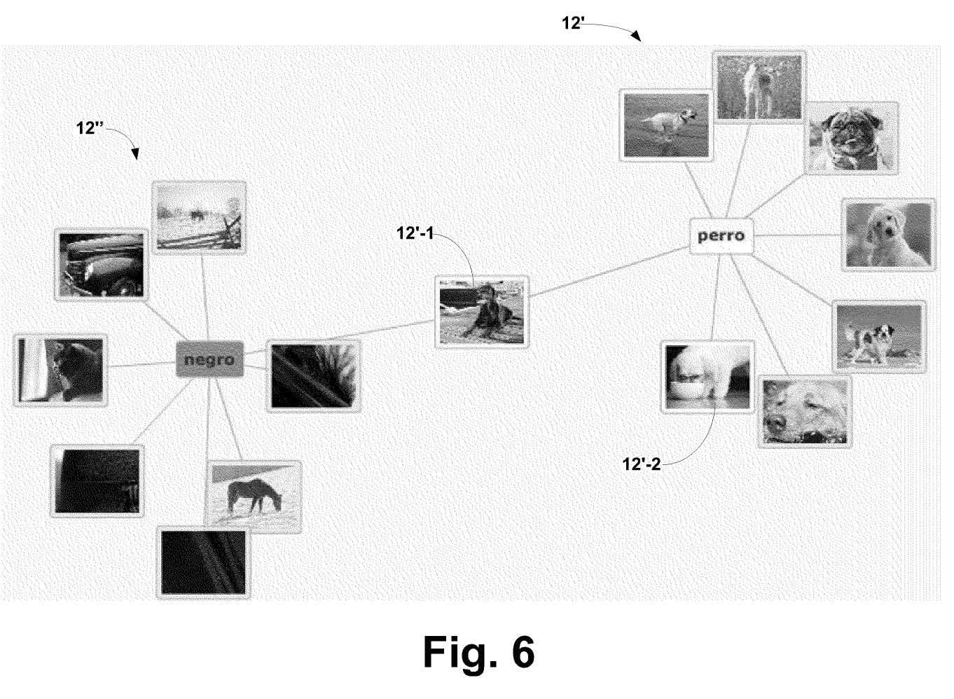

It is likely that the student, upon seeing image cluster 12′, may very well recall the meaning of “perro” or alternatively, deduce it from the common features of the images. However, should he still not recall the meaning of the word, he might select image 12′-1, at which point the screen takes on the appearance of FIG. 5, showing the word “negro” (black) alongside image 12′-1. Apparently, this was the only word associated with image 12′-1, or a group of words would have been displayed. Should the student then select the word “negro”, the display will take on the appearance of FIG. 6. A cluster 12″ has appeared, including the word “negro” surrounded by a collection of images showing black items.

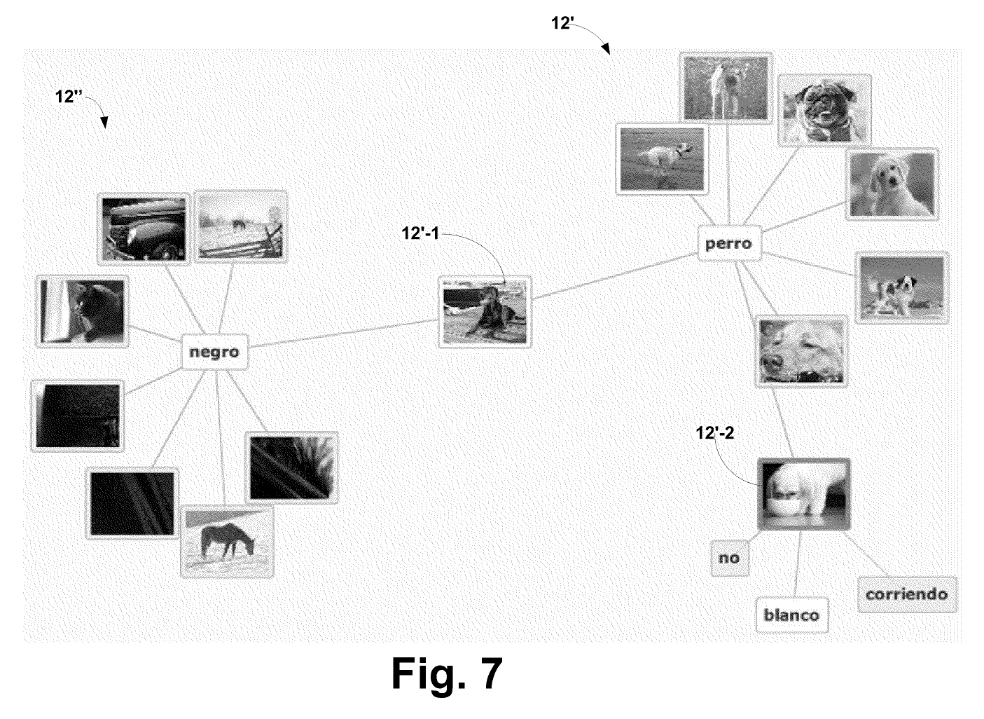

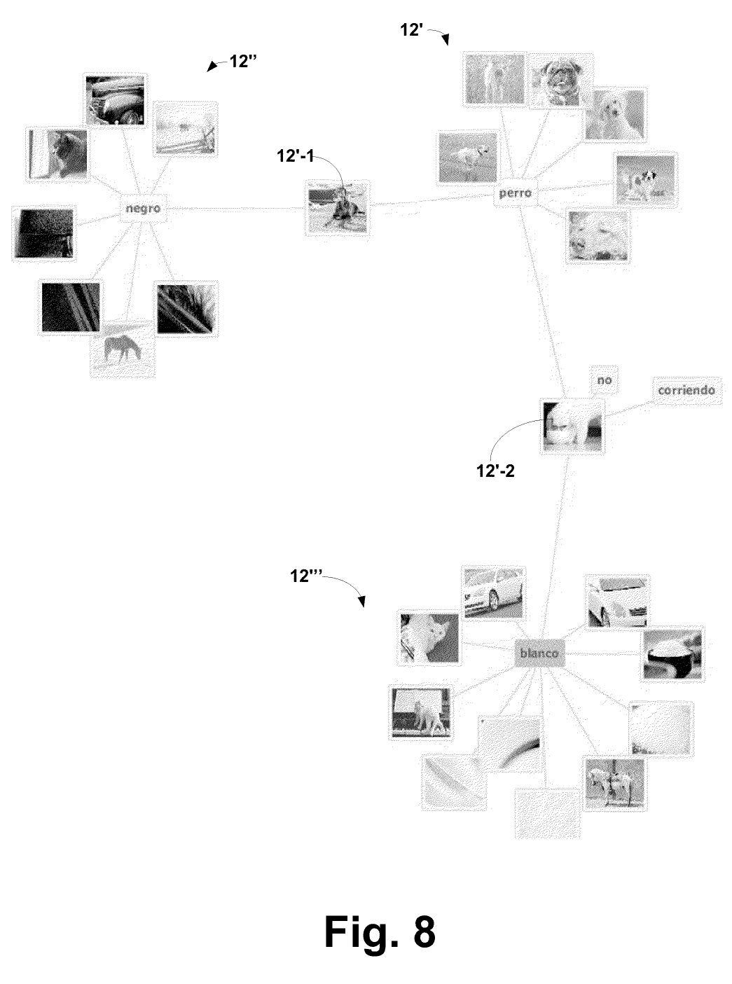

The student might then return to image cluster 12′ and select image 12′-2. The screen would then take on the appearance of FIG. 7, with the words “no”, “blanco” and “corriendo” appearing next to image 12′-2, forming a word cluster about the image. Should the student then select the word “blanco” (white), the display will take on the appearance of FIG. 8. An image cluster 12′″ has appeared, including the word “blanco” surrounded by a collection of images showing white items. The display has now taken on the appearance of a tree made up of a plurality of clusters, each linked to another cluster by a common image.

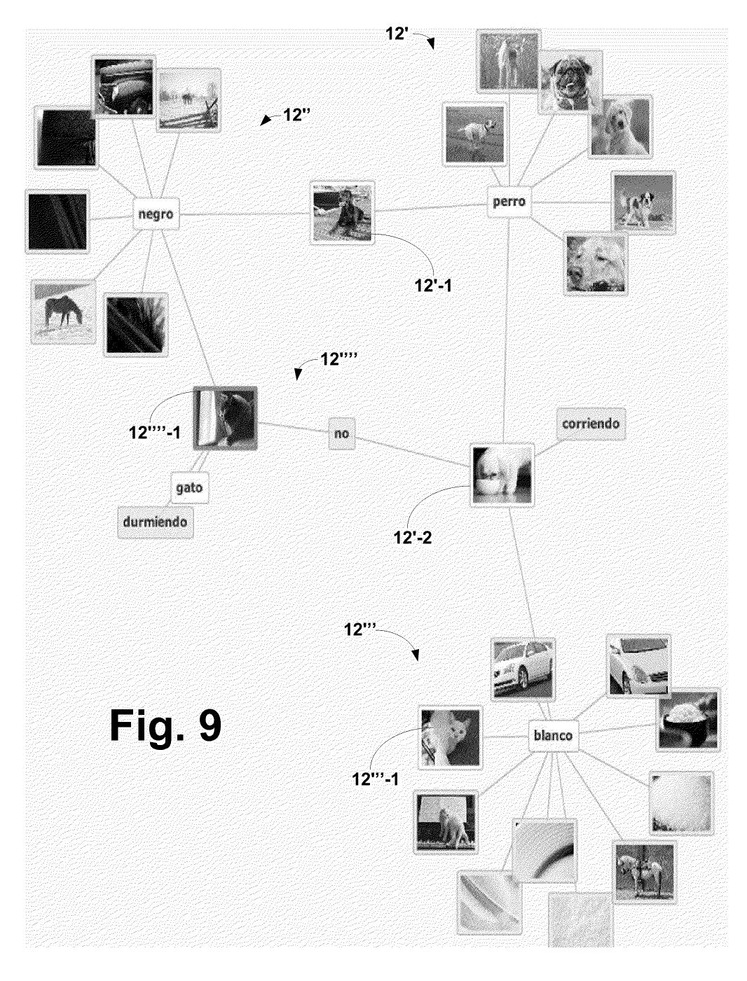

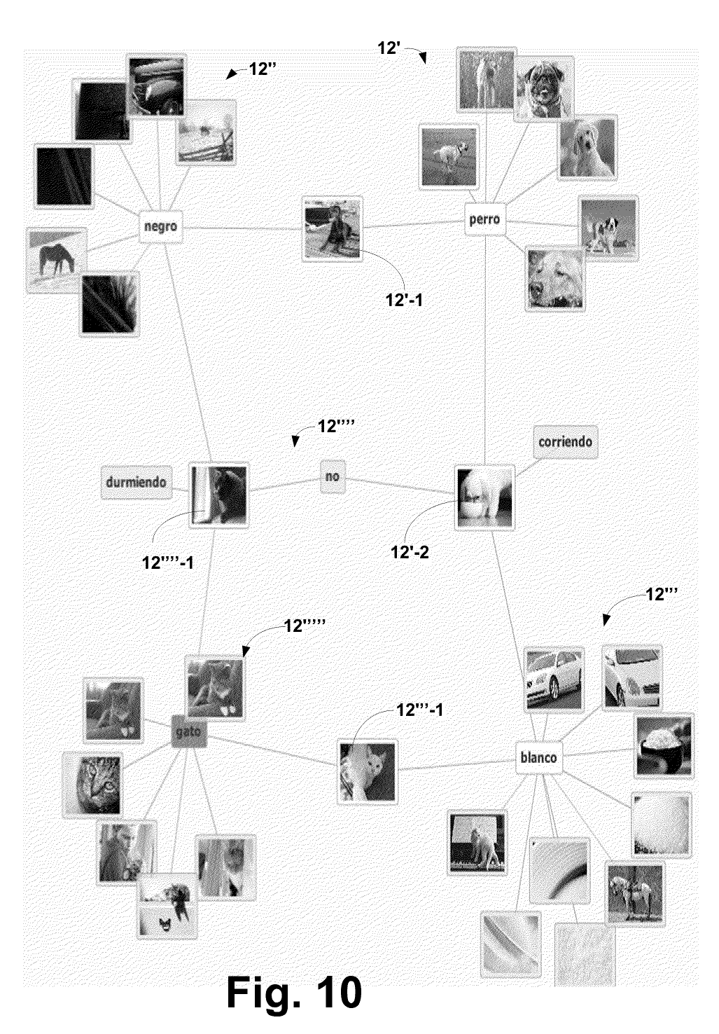

The student might then return to the word cluster for image 12′-2 and select the word “no.” The display will take on the appearance of FIG. 9. A new image cluster 12″″ has appeared, including the word “no” and a single image 12′″-1 showing a black cat. This image is also part of image cluster 12″. In FIG. 9, the student has also selected image 12″″-1, forming a word cluster about the image containing “gato” and “durmiendo.”

The student might then select the word “gato” (cat), and the display will take on the appearance of FIG. 10. A new image cluster 12′″″ has appeared, including the word “gato” and a plurality of images showing cats. Image cluster 12′″″ contains the images 12′″-1 and 12″″-1 which it shares in common with other image clusters. The display could be described in general as a collection of image clusters formed about a word relating the images in a cluster and word clusters formed about an image relating the words in the cluster. In general, two words are connected by an image that describes their commonality and two images are connected by a word that describes their commonality.

Those skilled in the art will appreciate that the described process of constructing the tree of FIG. 10 and the tree itself constitute particularly effective vehicles for teaching language in a natural, contextual environment which immerses the student.

In defining the words or phrases to be used in the concept, it becomes important to avoid common words, like “the.” This could be achieved in a number of ways, including providing a specific list of excluded words or excluding words which appear more than a prescribed number of times in the lesson curriculum. Similarly, it would be beneficial to define word clusters, so that if a student selects a common word, the machine would recognize the entire associated phrase.

The above description is largely directed to the user action on the image triggering a list of corresponding words or phrases to be displayed, and to a user action on a word or phrase triggering a corresponding set of images. However, the “correspondence” may be by way of synonyms, related words, antonyms, or text.

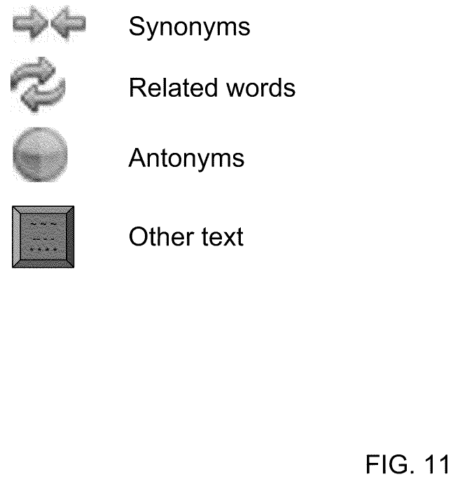

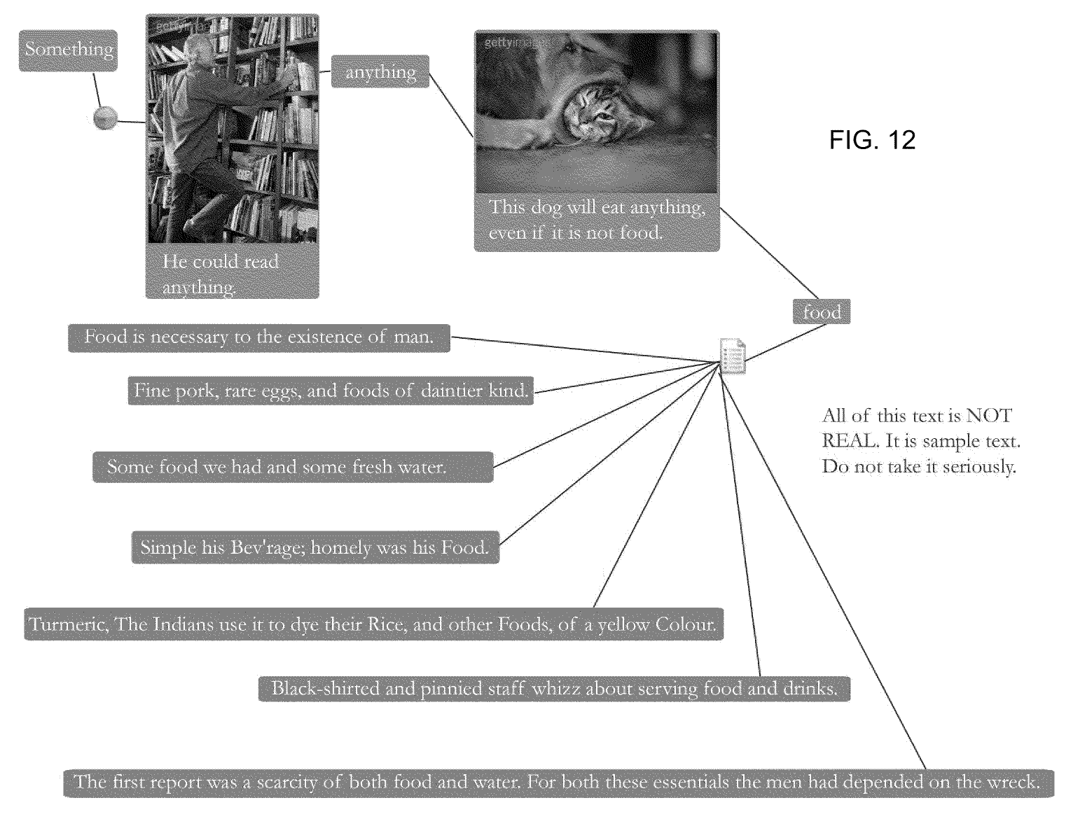

For example, FIG. 11 shows several different icons that correspond to the relationships shown, such as synonyms, related words, antonyms and text. In FIG. 12, when the word food is selected by the user, rather than show all images that are associated with the word food, the system shows other textual content that uses the word food. As described previously, the list of text shown may be limited to that previously studied by the student.

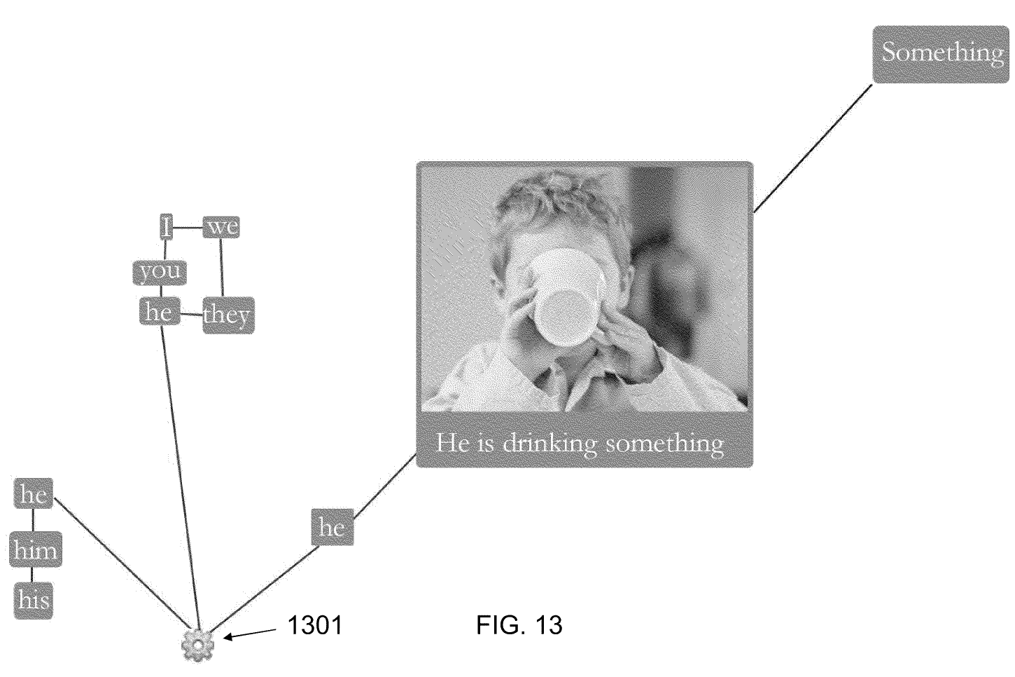

FIG. 13 depicts a user selecting the word he. The gear icon 1301 may appear from a pull down menu, or may correspond to a prescribed set of keys, or may otherwise be selected. When this icon is selected, various forms of related words are shown. In the example of FIG. 13, selecting he display other forms: his, him, etc. Various tenses, plural and singular, etc. may be shown in such a case, forcing the user to think through the word and its forms, and reinforcing the learning. The actual relationship between further content displayed, and the image or word or phrase selected, may be selected in real time at the time of the lesson, in advance by the user, or by a the software itself.

Although preferred embodiments of the invention have been disclosed for illustrative purposes, those skilled in the art will appreciate that many additions, modifications and substitutions are possible, without departing from the scope and spirit of the invention as defined by the accompanying claims.

What is claimed:

1. An automated method for teaching a stored curriculum to a student, the curriculum containing a plurality of concepts and a plurality of viewable elements associated with each concept, said method comprising the steps of:
enabling the special selection of a concept by the student;
in response to the special selection, displaying at least a subgroup of the viewable elements associated with the specially selected concept;
enabling a special sub-selection by the student of one of the displayed viewable elements; and
in response to the special sub-selection, displaying at least a subgroup of any concepts associated with the specially sub-selected viewable element.

2. The method of claim 1 wherein one of the subgroups comprises the entire group.

3. The method of claim 1 wherein the curriculum contains lessons and the displayed subgroup of viewable elements contains elements previously displayed to the student during a lesson.

4. The method of claim 3 wherein the displayed subgroup of concepts contains concepts previously displayed to the student during a lesson.

5. The method of claim 1 wherein the curriculum contains lessons and the displayed subgroup of concepts contains concepts previously presented to the student during a lesson.

6. The method of any one of claims 1-5 wherein the curriculum involves teaching a language, the concept is a word or phrase in the language, and the viewable element is a graphic or image associated with a word or phrase in the language.

7. The method of claim 1 wherein the subgroup of viewable elements comprises a cluster of viewable elements linked by the concept.

8. The method of claim 7 wherein the subgroup of concepts comprises a cluster of viewable elements linked by the sub-selected viewable element.

9. The method of claim 8 wherein the subgroup of viewable elements and the subgroup concepts are part of a tree in which two viewable elements are linked by a concept and two concepts are linked by a viewable element.

10. The method of claim 1 wherein the subgroup of concepts comprises a cluster of viewable elements linked by the sub-selected viewable element.

11. An automated system for teaching a stored curriculum to a student, the curriculum containing a plurality of concepts and a plurality of viewable elements associated with each concept, said system including a display and comprising:
first selection means operable by the student to specially select a concept;
a first controller responsive to the first selection means to produce on the display at least a subgroup of the viewable elements associated with the specially selected concept;
second selection means operable by the student to specially sub-select one of the displayed viewable elements; and
a second controller responsive to the second selection means to cause the display of at least a subgroup of any concepts associated with the specially sub-selected viewable element.

12. The system of claim 11 wherein one of the subgroups comprises the entire group.

13. The system of claim 11 wherein the curriculum contains lessons and the displayed subgroup of viewable elements contains elements previously displayed to the student during a lesson.

14. The system of claim 13 wherein the displayed subgroup of concepts contains concepts previously displayed to the student during a lesson.

15. The system of claim 11 wherein the curriculum contains lessons and the displayed subgroup of concepts contains concepts previously presented to the student during a lesson.

16. The system of any one of claims 11-15 wherein the curriculum involves teaching a language, the concept is a word or phrase in the language, and the viewable element is a graphic or image associated with a word or phrase in the language.

17. The system of claim 11 further comprising an indexer maintaining a record of associations between concepts and viewable elements.

18. A method of teaching language comprising performing, on a computer, a plurality of lessons by presenting a student with viewable images in connection with teaching prescribed words or phrases;
permitting special selection of a word or phrase during at least one of said lessons, and upon said special selection, displaying viewable images presented in connection with teaching said word or phrase and used during others of said lessons.

19. The method of claim 18 wherein said displaying comprises displaying viewable images presented in connection with lessons said student has previously successfully completed.

20. The method of claim 18 wherein the viewable images are presented as an image cluster in association with the specially selected word or phrase.

21. The method of claim 18 further comprising permitting special selection of one of said images during at least one of said lessons, and upon said special image selection, displaying words or phrases presented in connection with said specially selected viewable image during others of said lessons.

22. The method of claim 21 wherein said words or phrases are presented as a word or phrase cluster in association with the specially selected image.

23. The method of claim 22 wherein the viewable images are presented as an image cluster in association with the specially selected word or phrase.

24. The method of claim 23 wherein image clusters and word or phrase clusters are displayed in the form of a tree in which specially selected words or phrases of an image cluster are linked by an image and specially selected images of a word or phrases of cluster are linked by a specially selected word or phrase.

25. A method comprising presenting a language learner with content in a target language, accepting a selection from said language learner that specially designates one or more words of said content, and displaying images associated with said specially designated one or more words, and which images have been used in prior language learning lessons studied by said learner.

26. The method of claim 25 wherein said method comprises determining if more than a predetermined number of prior language learning lessons that have been studied by said learner have used said images associated, and if not, displaying images associated that have not been previously studied.

27. The method claim 25 further comprising accepting a selection of one or more of said displayed images, and displaying text associated with said one or more images.

28. The method of claim 27 further comprising determining which text associated has been included in prior lessons studied by said learner.

29. A method of teaching language comprising performing, on a computer, a plurality of lessons by presenting a student with viewable in connection with teaching prescribed words or phrases;
permitting special selection of a word, phrase, or image during at least one of said lessons, and upon said special selection, displaying content related to said word, phrase or image, wherein said content has a user selectable relationship to said selected word, phrase, or image.

30. The method of claim 29 wherein the selected relationship is selected in advance of said special selection.

31. The method of claim 29 wherein the selectable relationship includes synonyms.

32. The method of claim 29 wherein the selected relationship includes other forms of the selected word, phrase, or image.

33. The method of claim 29 wherein the user selects said relationship in real time.
